(19) United States
(12) Patent Application Publication
(10) Pub. No.: US 2008/0145643 A1
(43) Pub. Date: Jun. 19, 2008

(54) Thermal barrier coating

(75) Inventors: George H. Reynolds, Sanford, ME (US); Christopher W. Strock, Kennebunk, ME (US)

Correspondence Address: BACHMAN & LAPOINTE, P.C. (P&W), 900 CHAPEL STREET, SUITE 1201, NEW HAVEN, CT, 06510-2802, US

(73) Assignee: United Technologies Corporation

(21) Appl. No.: 11/640,072

(22) Filed: Dec. 15, 2006

(51) Int. Cl. B05D 1/36; B32B 3/00

(52) U.S. Cl. 428/316.6; 427/261

(57) ABSTRACT

A bond coat is applied to a substrate of a gas turbine engine component the component. A barrier coat is applied atop the bond coat. The applying of the bond coat includes: applying a first layer having an as-applied first roughness; and applying a second layer atop the first layer, the second layer having an as-applied second roughness, greater than the first roughness. In the resulting coating system, the first and second layers may have different properties (e.g., greater porosity, pore size, and/or splat size for the second layer).

### BACKGROUND OF THE INVENTION

The invention relates to gas turbine engines. More particularly, the invention relates to thermal barrier coatings for gas turbine engines.

Gas turbine engine gaspath components are exposed to extreme heat and thermal gradients during various phases of engine operation. Thermal-mechanical stresses and resulting fatigue contribute to component failure. Significant efforts are made to cool such components and provide thermal barrier coatings to improve durability.

Exemplary thermal barrier coating systems include two-layer thermal barrier coating systems. An exemplary system includes a NiCoCrAlY bond coat (e.g., low pressure plasma sprayed (LPPS)) and a yttria-stabilized zirconia (YSZ) thermal barrier coat (TBC) (e.g., air plasma sprayed (APS)). While barrier coat layer is being deposited or during an initial heating cycle, a thermally grown oxide (TGO) layer (e.g., alumina) forms atop the bond coat layer. As time-at-temperature and the number of cycles increase, this TGO interface layer grows in thickness. U.S. Pat. Nos. 4,405,659 and 6,060,177 disclose exemplary systems.

Exemplary TBCs are applied to thicknesses of 5-40 mils and can provide in excess of 300° F. temperature reduction to the base metal. This temperature reduction translates into improved part durability, higher turbine operating temperatures, and improved turbine efficiency.

Nevertheless, there remains need for improvement in component durability.

### SUMMARY OF THE INVENTION

One aspect of the invention involves a method for coating a gas turbine engine component. A bond coat is applied to a substrate of the component. A barrier coat is applied atop the bond coat. The applying of the bond coat includes: applying a first layer having an as-applied first roughness; and applying a second layer atop the first layer, the second layer having an as-applied second roughness, greater than the first roughness.

In various implementations, the method may be implemented in the remanufacturing of a baseline component or the reengineering of a configuration thereof.

Another aspect of the invention involves a gas turbine engine component comprising a metallic substrate. A coating is on the substrate. The coating includes a bond coat and a barrier coat atop the bond coat. The bond coat comprises: a base layer; and a second layer atop the base layer and having a greater characteristic pore size and/or splat size than the base layer.

In various implementations, a TGO may be between the bond coat and barrier coat. The second layer may have a greater characteristic porosity than the base layer.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIG. 1 is a sectional view of coated substrate.

FIG. 2 is a flowchart of a process for coating the substrate of FIG. 1.

Like reference numbers and designations in the various drawings indicate like elements.

### DETAILED DESCRIPTION

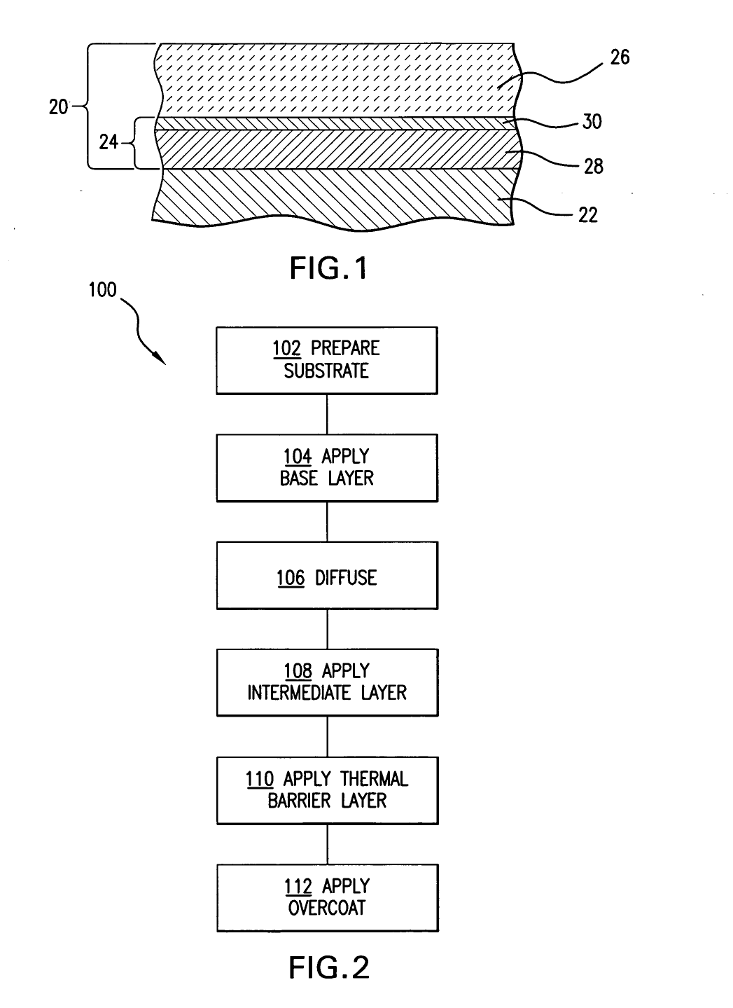

FIG. 1 shows a coating system 20 atop a superalloy substrate 22. The system may include a bond coat 24 atop the substrate 22 and a TBC 26 atop the bond coat 24. The exemplary bond coat 24 includes a base layer 28 and an intermediate layer 30. As is discussed below, the properties of the base layer 28 may be chosen for adhesion to, and protection of, the substrate 22 while the properties of the intermediate layer may be chosen for adhesion to the TBC 26. Exemplary substrates are of nickel- or cobalt-based superalloys used for hot gaspath components such as: turbine section blades; turbine section vanes; turbine section blade outer air seals; combustor shell pieces; combustor heat shield pieces; combustor fuel nozzles; and combustor fuel nozzle guides.

An exemplary coating process 100 includes preparing 102 the substrate (e.g., by cleaning and surface treating). A precursor of the bond coat base layer 24 is applied 104. An exemplary application 104 is of an MCrAlY, more particularly a NiCoCrAlY material. Advantageous high temperature protective properties for the base layer 24 may be associated with properties that are disadvantageous for adhesion to the TBC 26. For example, advantageously high density and low porosity for protection may be associated with a surface roughness that is lower than desired for TBC adhesion. An exemplary as-applied roughness of the base layer 28 is less than 300 microinches Rₐ (e.g., 200+/−40 microinch Rₐ or less). An exemplary application is via a spray from a powder source of less than 45 microns particle size to achieve said roughness. An exemplary application is via a high-velocity oxy-fuel (HVOF) process. An exemplary application is to a thickness of 0.003-0.010 inch. LPPS, VPS, EBPVD, cold spray, and any other appropriate process may be used to provide a dense, low oxide, base layer 28 that provides good oxidation and corrosion resistance.

After the application 104, the precursor may be diffused 106. An exemplary diffusion is via heating (e.g., to at least 1900° F. for a duration of at least 4 hours) in vacuum or nonreactive (e.g., argon) atmosphere. The exemplary diffusion 106 is effective to create a metallurgical bond between the base layer and the substrate. The diffusion may also reduce the diffusion path length for protective oxide-forming species. Alternatively diffusion steps may occur after applying the intermediate layer and/or the TBC, if at all.

After the application 104 and the optional diffusion 106, the intermediate layer 30 may be applied 108. The exemplary intermediate layer may be of essentially the same material as the base layer precursor and may be applied via similar techniques. However, it is preferable that the intermediate layer be applied to yield advantageous adhesion of the TBC. The intermediate layer 30 may have a surface roughness that may be greater than that of the base layer 28. An exemplary as-applied roughness is 300-800 microinch Rₐ, more narrowly, 500+/−100 microinch Rₐ. This may be 150-300% (or more) of the as-applied roughness of the base layer 28. Such roughness may be achieved by using a coarser source powder (e.g., at least 150+% of the characteristic particle size of the base layer source powder) and/or varying application parameters. An exemplary powder size is 45-70 microns. Other properties may differ from the base layer (e.g., as discussed below).

In ascending order of typical roughness, alternative methods for the application 108 include: EBPVD, cold spray, HVOF and LPPS, APS, wire arc and wire flame. Other options include slurry methods where a slurry is made with an optional binder and powder, then applied to the base layer by spraying, dipping, brushing, etc. Then the binder baked off and the metallics sintered for adhesion. The slurry has large particles that produce the roughness. The slurry may include fine particles and/or elements or alloys that melt below the sintering temperature, to promote sintering and adhesion of the intermediate layer to the base layer by sintering and/or brazing.

Exemplary thickness of the intermediate layer 30 is less than (e.g., 10-50% of) the thickness of the base layer 28. For example, the absolute and relative thicknesses may be chosen to make the oxidation and corrosion resistant base layer as thick as possible to maximize the effect of those properties. The rough intermediate layer need only be thick enough to provide desired improvements in TBC bonding. An exemplary intermediate layer thickness is at least 0.001 inch, more narrowly 0.002-0.004 inch would be required.

After the application 108, the TBC 26 may be applied 110. The exemplary application 110 is of a yttrium-stabilized zirconium oxide (e.g., 6-8% yttrium by weight, nominal 7YSZ). An environmental barrier coat (“overcoat”—not shown, if any) may then be applied 112. An exemplary overcoat is one that is not wet by, nor reacts with calcium-magnesium-alumino-silicates (CMAS) or ingested dust or sand.

Generally, for good oxidation and corrosion resistance, the base layer 28 would have some to all of the following attributes relative to the intermediate layer 28: lower roughness; greater density; smaller pores; lower porosity (volume fraction), smaller oxide particles; and less oxide content (mass fraction); smaller splats, and smaller oxide stringers. Various of these properties may be observed by metallography (e.g., with use of etchant). To the extent measurable, the vestigal surface roughness may differ in the same way as the as-applied surface roughness.

The splat structure results from the impact of spray droplets. The droplets flatten and solidify, leaving traces of the individual splat structure within the coating as further splats build up. An exemplary characteristic splat size of the intermediate layer 30 may be at least twice that of the base layer 28. The characteristic may be a median, mean, or modal value, with or without weighting based upon splat size. This may be measured as a cross-sectional area in a cross-sectioning perpendicular to the coating surface.

In development, splats may readily be observed by adding a tagging component to the sprays. The tagging component may then highlight the splat interfaces. However, once process parameters are finalized, the tagging component may be eliminated. In the absence of a tagging component, a dye may be infiltrated into the coating after coating application. An exemplary dye is a rhodium-B fluorescent dye.

In some reengineering or remanufacturing situations, the foregoing teachings may be applied to reduce total bond coat thickness while improving or maintaining TBC adhesion and/or oxidation resistance. Other combinations of such benefits may also be achieved. In the reengineering from a baseline bond coat, the baseline could have properties in the paragraph above falling in between those of the base layer 28 and intermediate layer 30. Performance (e.g., spall resistance) may be measured by observation or direct testing. An exemplary observation comprises thermal cycling with differential heating and cooling (heating one portion of the coating while cooling another portion of the part). Spallation may be observed after a sufficient number of cycles.

One or more embodiments of the present invention have been described. Nevertheless, it will be understood that various modifications may be made without departing from the spirit and scope of the invention. For example, and applied as a reengineering of an existing component, details of the existing component may influence or dictate details of any particular implementation. Accordingly, other embodiments are within the scope of the following claims.

What is claimed is:

1. A gas turbine engine component comprising:
a metallic substrate;
a coating on the substrate comprising:
a bond coat; and
a barrier coat atop the bond coat,
wherein the bond coat comprises:
a base layer; and
a second layer atop the base layer and having at least one of greater characteristic pore size than the base layer and greater characteristic splat size than the base layer.

2. The component of claim 1 used as a gas turbine engine component selected from the group consisting of:
turbine section blades;
turbine section vanes;
turbine section blade outer air seals;
combustor shell pieces;
combustor heat shield pieces;
combustor fuel nozzles; and
combustor fuel nozzle guides.

3. The component of claim 1 wherein:
the base layer is 2-10 times thicker than the second layer.

4. The component of claim 1 wherein:
the base layer and second layer consist essentially of the same chemical composition.

5. The component of claim 1 further comprising
the base layer is partially diffused with the substrate.

6. The component of claim 1 wherein:
the barrier coat comprises at least 50%, by weight, rare-earth based stabilized zirconia.

7. The component of claim 1 wherein:
the bond base layer and second layer each comprise at least 50%, by weight, NiCoCrAlY material.

8. The component of claim 1 wherein:
said substrate consists essentially of a cast nickel-based superalloy.

9. The component of claim 1 wherein:
the second layer has greater porosity than the base layer.

10. The component of claim 1 wherein:
the second layer has greater characteristic splat size than the base layer.

11. The component of claim 1 wherein:
the second layer has greater characteristic pore size than the base layer.

12. A method for coating a gas turbine engine component, the method comprising:
applying a bond coat to a substrate of the component; and
applying a barrier coat atop the bond,
wherein the applying of the bond coat comprises:
applying a first layer having an as-applied first roughness; and
applying a second layer atop the first layer, the second layer having an as-applied second roughness, greater than the first roughness.

13. The method of claim 12 wherein:
the second roughness is 300-800 microinch Rₐ and at least 150% of the first roughness.

14. The method of claim 12 wherein:
the applying of the first layer comprises spraying of a first powder having a characteristic first particle size; and
the applying of the second layer comprises spraying of a second powder having a characteristic second particle size, greater than the first particle size.

15. The method of claim 14 wherein:
the first and second powders consist essentially of the same chemical composition.

16. The method of claim 14 wherein:
the first and second powders consist essentially of a NiCoCrAlY material.

17. The method of claim 14 wherein:
the first and second powders consist essentially of a NiCoCrAlY material of the same chemical composition.

18. The method of claim 14 wherein:
the first layer is applied to a greater thickness than the second layer.

19. The method of claim 12 further comprising:
removing a baseline coating having a monolithic bondcoat thicker than said bond coat.

20. A method for engineering a coating for a gas turbine engine component, the method comprising:
applying a test coating to the substrate, the applying comprising:
applying a bond coat to the substrate, including first and second layers of different as-applied roughness; and
applying a barrier coat atop the bond;
measuring resistance of the test coating to at least one of oxidation and spallation; and
repeating the applying and measuring with different relative properties of the first and second layers until a desired resistance is determined.

21. The method of claim 20 wherein:
the measuring comprises cycling a differential heating; and
observing coating condition.

22. The method of claim 20 being a reengineering form a baseline coating wherein:
the reengineered coating has smaller overall bond coat thickness than a bond coat thickness of the baseline coating.
